(19) United States
(12) Patent Application Publication
(10) Pub. No.: US 2003/0236338 A1
(43) Pub. Date: Dec. 25, 2003

(54) Formed article of fiber-reinforced polypropylene resin

(75) Inventors: Katsuhisa Kitano, Ichihara-shi (JP); Takashi Sanada, Ichihara-shi (JP); Kenji Atarashi, Sodegaura-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/421,814

(22) Filed: Apr. 24, 2003

(30) Foreign Application Priority Data
Apr. 26, 2002 (JP) 2002-126180

(51) Int. Cl. C08K 3/40

(52) U.S. Cl. 524/494; 524/543

(57) ABSTRACT

Disclosed is a formed article made of a fiber-reinforced polypropylene resin comprising from 20 to 95% by weight of a polypropylene resin and from 5 to 80% by weight of fibers, wherein in the formed article the polypropylene has an intrinsic viscosity [η] of from 1.05 dl/g to 2.00 dl/g, the fibers have a weight average fiber length of from 1 mm to 10 mm, and a degree of dispersion of the fibers is from 0 to 1.2. The formed article is superior in both mechanical strength and fatigue characteristic.

### BACKGROUND OF THE INVENTION

1. Field of the Invention

The present invention relates to a formed article made of a fiber-reinforced polypropylene resin having a superior mechanical strength and a superior fatigue characteristic.

2. Description of the Related Art

Polypropylene resin is in wide use as a general purpose resin because of its good moldability, good chemical resistance and low specific gravity. However, it is not always satisfactory in respect of mechanical strength and heat resistance and hence is rather restricted in its use. As a means for ameliorating such shortcomings and improving the mechanical strength of polypropylene resin such as rigidity and impact strength, it is already known to incorporate fillers, glass fiber, or the like into the resin. In industrial practice, also, there have been produced glass fiber reinforced polypropylene resins obtained by mixing short fibers, such as chopped strands, with polypropylene resin and granulating the mixture with a kneader.

However, such a short-fiber-reinforced polypropylene resin as that mentioned above, which is one such that fibers to be used for its production have lengths of 1 mm or shorter (usually 0.5 mm or shorter) and the fibers contained therein must be broken during its kneading in an extruder, naturally has a limitation in improvement in mechanical strength, being unable to fully comply with a request for a higher mechanical strength.

Accordingly, some attempts have been made to increase the mechanical strength greatly by using fiber of large fiber length. JP-A-3-121146 discloses a method for producing a long-fiber-reinforced thermoplastic resin pellet using a pultrusion process, the method comprising a step of impregnating continuous fiber strands with molten thermoplastic resin while the fiber strands are being pulled, thereby incorporating, into the resin, 5-80% by weight (based on the total weight) of fibers arranged substantially in parallel each other.

JP-A-02-292008, JP-A-02-292009 and JP-A-09-187841 each disclose that when a long-fiber-reinforced thermoplastic resin composition is molded by use of a properly devised molding machine, mold and molding conditions, letting fibers have lengths as long as possible results in an improved mechanical strength of a molded article.

On the other hand, JP-A-05-017631 and JP-A-08-164521 each disclose that a long fiber-reinforced thermoplastic resin composition can exhibit a superior mechanical strength when long fibers are dispersed therein uniformly or there are minimized vacancies therein.

Moreover, JP-A-05-017631 and JP-A-05-239286 each disclose that reduction of the melt viscosity of a reinforced thermoplastic resin results in improvement in dispersablity and reduction of vacancies in boundary surfaces.

A normal mechanical strength are improved through the approaches disclosed the above-cited published applications for patents. However, a long fiber-reinforced thermoplastic resin has recently come to be used as a structural member for long use due to its excellent physical properties and, accordingly, has come to be required to have a reliability as a member for long use. One of the important characteristics required is a fatigue characteristic. However, the level of improvement in fatigue characteristics achieved in molded articles made of known compositions is unsatisfactory.

### SUMMARY OF THE INVENTION

The object of the present invention is to provide a formed article made of a fiber-reinforced polypropylene resin having a superior mechanical strength and a superior fatigue characteristic.

Taking such present circumstances into consideration, the present inventors found that the above-mentioned problems can be solved by a formed article made of a fiber-reinforced polypropylene resin containing a polypropylene resin whose content is within a specific range and fibers whose content is within a specific range, wherein in the formed article the polypropylene resin has an intrinsic viscosity within a specific range, the fibers have a weight average fiber length within a specific range and a degree of dispersion of the fibers is within a specific range. Thus, they have accomplished the invention.

That is, the present invention provides a formed article made of a fiber-reinforced polypropylene resin comprising from 20 to 95% by weight of a polypropylene resin and from 5 to 80% by weight of fibers, wherein in the formed article the polypropylene resin has an intrinsic viscosity [η] of from 1.05 dl/g to 2.00 dl/g, the fibers have a weight average fiber length of from 1 mm to 10 mm, and a degree of dispersion of the fibers is from 0 to 1.2, provided that the contents of the polypropylene resin and the fibers are each based on the combined amount of the polypropylene resin and the fibers.

### BRIEF DESCRIPTION OF THE DRAWINGS

FIG. 1 is Photograph No. 1, which is the photograph used for determination of the degree of dispersion of the fibers in the formed article of Example 1.

FIG. 2 is Photograph No. 2, which shows the state of fibers in a cut surface of the formed article of Comparative Example 1.

FIG. 3 is Photograph No. 3, which is the photograph used for determination of the degree of dispersion of the fibers in the formed article of Comparative Example 2.

### DESCRIPTION OF PREFERRED EMBODIMENTS

The polypropylene resin in the present invention includes propylene homopolymers, ethylene-propylene random copolymers, propylene-α-olefin random copolymers, and composite polymers obtained by homopolymerizing propylene first and then copolymerizing propylene and ethylene to form an ethylene-propylene copolymer portion. In the present invention, propylene copolymers included in the polypropylene resin are copolymers containing repeating units derived from propylene in an amount greater than 50 mol % the amount of the whole repeating units. These polymers may be used singly or as a blend of at least two of them. In addition, the propylene resin may be a modified propylene resin in which a part or the whole part of the polypropylene resin is modified with an unsaturated carboxylic acid or a derivative thereof.

Specific examples of the α-olefin include 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene and 1-dodecene. Among these, preferred are 1-butene, 1-pentene, 1-hexene and 1-octene.

The content of the polypropylene resin is from 20 to 95% by weight, preferably from 25 to 90% by weight, and more preferably from 30 to 80% by weight.

As the fibers in the present invention, glass fibers, carbon fibers, metal fibers, aromatic polyamide fibers and the like can be used. The content of the fibers is from 5 to 80% by weight, preferably from 10 to 75% by weight, and more preferably from 20 to 70% by weight. When the content of the fibers is too small, no sufficient improvement in mechanical strength such as rigidity and impact strength can be attained, When the content of the fibers is too large, it will become greatly difficult to produce and shape a fiber-reinforced polypropylene resin.

The weight average fiber length of the fibers in the formed article is from 1 mm to 10 mm, and preferably from 1.5 to 5 mm. When the fiber length is too short, a formed article obtained by forming a fiber-reinforced polypropylene resin can not be expected to have sufficient mechanical strength such as rigidity and impact strength. The weight average fiber length denotes an average length of the fibers in a formed article of the present invention and it can be determined by a method described in JP-A-2002-005924.

It is preferable to use fibers treated with various kinds of coupling agents or binders as the fibers in the present invention. The binders may be those known in the art, e.g. polyolefin resin, polyurethane resin, polyester resin, acrylic resin and epoxy resin. In particular, acid-modified polyolefin resin is preferred. As the coupling agents, aminosilane coupling agents, epoxysilane coupling agents and the like are preferred. The amount of a binder applied to the fibers is preferably from 0.1 to 2.0% by weight, more preferably from 0.2 to 1.0% by weight based on the fibers in view of prevention of damage of fibers and of generation of fuzz, in view of fully opening the fibers in an opening step, and in view of fully dispersing the fibers in the polypropylene resin.

The degree of dispersion of the fibers in the present invention is determined by a method described below using a photograph obtained by cutting an injection molded article perpendicularly to the direction in which the resin flew during the injection molding, polishing a section resulting from the cutting, and photographing the state of the fibers by use of a scanning electron microscope. Among the fibers found in the photograph, fibers which are found in the section and which are oriented almost parallel with the flow direction are analyzed. Since the fibers which are found in the section and which are oriented almost parallel with the flow direction are observed to be in an almost circle form, only the images of these fibers are analyzed. The definition of the degree of dispersion is given in accordance with the expansion method of the methods classified to a generally called segmentation method. Boundary lines of the images of all the dispersed objects found in the binarized image, that is, boundary lines of the images of the fibers in the present invention are expanded uniformly along their normals. The expansion is stopped at a time of coming into contact with an expanded image of a neighboring dispersed object or at a time of coming into contact with the periphery of the binarized image under the analysis. Thus, the binarized image is filled with the expanded images contained therein. In the above-mentioned manner, the area of the expanded image of each dispersed object is determined and then an average area of the expanded images of the dispersed objects and their standard deviation are calculated. The degree of dispersion is a value obtained by dividing the standard deviation of the areas of the expanded images by the average area of the expanded images.

The degree of dispersion of the fibers in the formed article of the present invention is from 0 to 1.2, and preferably from 0 to 1.1.

In the production of the formed article of the present invention, a resin composite comprising the polypropylene resin and the fibers is used. In the resin composite, it is preferable that substantially all the fibers have a length of not less than 2 mm and be arranged almost parallel with each other. In particular, for obtaining a formed article containing therein fibers having a weight average fiber length of 1 mm or more without damaging injection moldability, it is preferable that the resin composite be in the form of pellets having a length of from 2 to 50 mm and the fibers contained therein be arranged with a length substantially equal to that of the pellets.

Regardless of the molecular weight of the polypropylene resin used in the preparation of the resin composite, the polypropylene in the formed article of the present invention has an intrinsic viscosity [η] of from 1.05 dl/g to 2.00 dl/g, preferably from 1.15 dl/g to 1.90 dl/g. When the polypropylene resin in a formed article has an intrinsic viscosity within the above ranges, the formed article can have a superior mechanical strength and a superior fatigue characteristic. The intrinsic viscosity [η] of the polypropylene resin in a formed article can be measured by extracting only the polypropylene with boiling xylene, followed by measuring the intrinsic viscosity [η] in 135° C. tetralin by use of an Ubberhode's viscometer.

The fiber-reinforced polypropylene resin which constitutes the formed article of the present invention may, as needed, contain one or more kinds of thermoplastic resin other than the polypropylene resin, rubber, a nucleating agent or crystallization accelerator. In addition, the fiber-reinforced polypropylene resin may also contain, for example, stabilizers, e.g. antioxidants, heat stabilizers, neutralizing agents and ultraviolet absorbers, foam inhibitors, flame retarders, flame retarding aids, dispersing agents, antistatic agents, lubricants, antiblocking agents, e.g. silica, colorants, e.g. dyestuffs and pigments, and plasticizers. Moreover, it is also possible to use tabular or granular inorganic compounds such as glass flakes, mica, glass powder, glass beads, talc, clay, alumina, carbon black and wollastonite, or whiskers.

A method for preparation of the resin composite for use in the production of the formed article of the present invention is not particularly restricted, but preferred is a pultrusion process. The pultrusion process is basically a method comprising drawing a continuous fiber bundle and simultaneously impregnating it with resin. For example, known are a method in which impregnation is performed by passing a fiber bundle through an impregnation bath containing an emulsion, suspension or solution of resin, a method in which impregnation is performed in such a manner that resin is attached to a fiber bundle by spraying a powder of the resin to the fiber bundle or passing the fiber bundle through a bath containing the powder and then the resin is melted, and a method in which impregnation is performed by passing a fiber bundle in a crosshead and simultaneously supplying a resin to the crosshead from an extruder or the like. Particularly preferred is the method using a crosshead. It is preferable to heat the fiber bundle to an appropriate temperature prior to its impregnation with resin, thereby making the fiber bundle easy to open. Moreover, it is also preferable that prior to the impregnation with resin, a rather high tension be applied to the fiber bundle to open it. Although, in pultrusion processes, it is typical to carry out the operation of resin impregnation in a single step, it is also possible to perform this operation in two or more separate steps.

For reducing the degree of dispersion of fibers in a formed article to 1.2 or less, it is preferable to reduce the viscosity of a resin at the time of resin impregnation or to increase the take-up speed when the opening property of the fibers is increased by increasing the tension of the fibers applied during the resin impregnation in the course of pultrusion. It should be noted that it is important to reduce the viscosity of the resin during resin impregnation by increasing the resin temperature rather than by reducing the molecular weight of the resin. Moreover, it is preferable to knead the mixture while preventing the fiber length from becoming too short during injection molding.

### EXAMPLES

The present invention will be illustrated by reference to Examples. However, these are just illustrative and therefore the invention is not limited to the Examples.

### Comparative Example 1

Pellets of a resin composite used for the production of a formed article of Comparative Example 1 were prepared by the method described below. That is, a roving of a glass fiber bundle was taken up continuously and heated simultaneously. Thereafter, it was passed through a crosshead die. To the crosshead die, a propylene homopolymer (available as Sumitomo Noblene Z101A) molten in an extruder and a maleic anhydride-modified polypropylene resin (the quantity of maleic anhydride grafted=0.2 wt %, MI=30 g/10 min; the maleic anhydride-modified polypropylene accounting for 10 wt % of the whole polypropylene resin, that is, the combined resin consisting of the propylene homopolymer and the maleic anhydride-modified polypropylene) were supplied and the glass roving was impregnated with the combined resin in the crosshead die (crosshead temperature=330° C.). At this time, the take up rate of the glass roving and the amounts of the molten propylene homopolymer and the maleic anhydride-modified polypropylene resin to be supplied were controlled, so that the content of the glass fibers was adjusted to 40% by weight. After forming a strand of the resin composite by passing the roving containing the combined resin through the crosshead die and further through take-up rolls, the resulting strand was cut with a pelletizer, yielding pellets 9 mm long. Further, injection molding was carried out under the conditions shown below by use of an injection molding machine 150EN manufactured by The Japan Steel Works, Ltd. which contained a screw designed specifically for long fibers, yielding a formed article. An intrinsic viscosity [η] of the polypropylene resin, which is the combined resin, in the formed article was determined by extracting only the polypropylene resin to a boiling xylene and measuring in a 135° C. tetralin. A weight average fiber length of the fibers in the formed article was determined by a method described in JP-A-2002-5924.

Injection Conditions:

Molding temperature: 250° C.

Back pressure: 0 MPa

Plasticizing time: 21 seconds

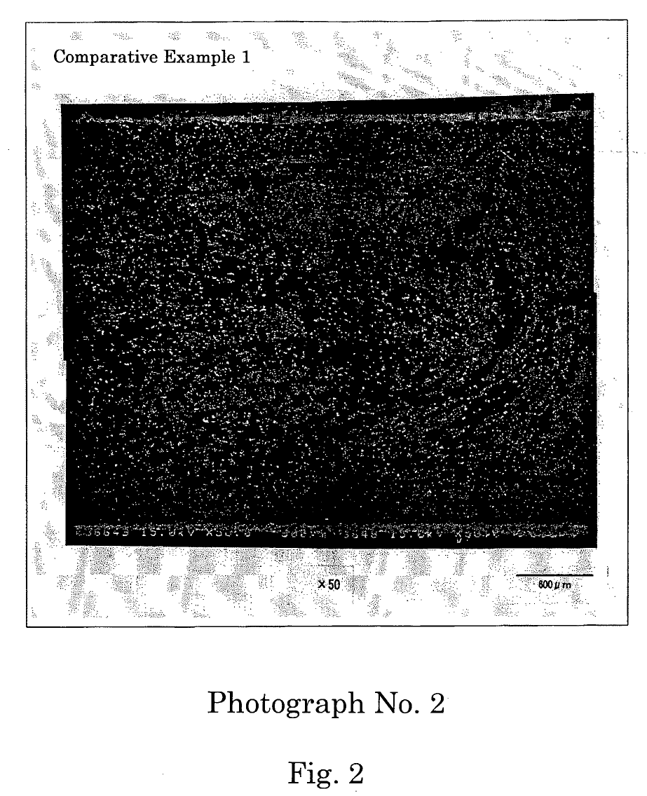

The resulting formed article was cut with a diamond cutter perpendicularly to the resin flow. After conditioning a section of the cut formed article by polishing with alumina for polishing, first that having a particle size of 1 μm, then that of 0.3 μm and at last that of 0.05 μm, the section was observed through a scanning electron microscope and the condition of the fibers in the section was photographed (FIG. 2: Photograph 2). Using this photograph, a monochrome image was captured into a computer with a scanner GT-9600 (manufactured by EPSON, resolution: 1600 dpi) under conditions set to a resolution of 300 dpi and a gradation of each pixel of 8 bit and was stored in the bitmap format. The image was then binarized with image analyzing software “A-Zo-kun” available from Asahi Engineering Co. The glass fibers were recognized as portions brighter than their peripheral regions. The degree of dispersion of the glass fibers in the binarized image was determined by use of the A-zo-kun.

Boundary lines of the images of all the dispersed objects found in the binarized image, that is, boundary lines of the images of the glass fibers in the present invention, were expanded uniformly along their normals. The expansion was stopped at a time of coming into contact with an expanded image of a neighboring dispersed object or a time of coming into contact with the periphery of the binarized image under the analysis. As a result, the binarized image was filled with the expanded images of the dispersed objects contained therein.

The area of the expanded image of each dispersed object was determined and then an average area of the expanded images of the dispersed objects and their standard deviation were calculated. From these values, a degree of dispersion was calculated by dividing the standard deviation of the areas of the expanded images by the average area of the expanded images. This value is shown in Table 1.

Using a formed article obtained in the same manner as described above, measurement was carried out under the conditions shown below in accordance with the bend test with one side support, ASTM D671-71T Method B. Thus, evaluation was performed based on the number of reciprocative vibrations until rupture of the formed article. The result is shown in Table 1.

Test machine: Repeated Vibration Fatigue Tester (Model B70TH) manufactured by Toyo Seiki Seisaku-syo, LTD.

Shape of specimen: TYPE A

Measuring temperature: 23° C.

Repeating rate: 30 Hz

Loaded stress: 40, 45, 50 MPa

### Example 1

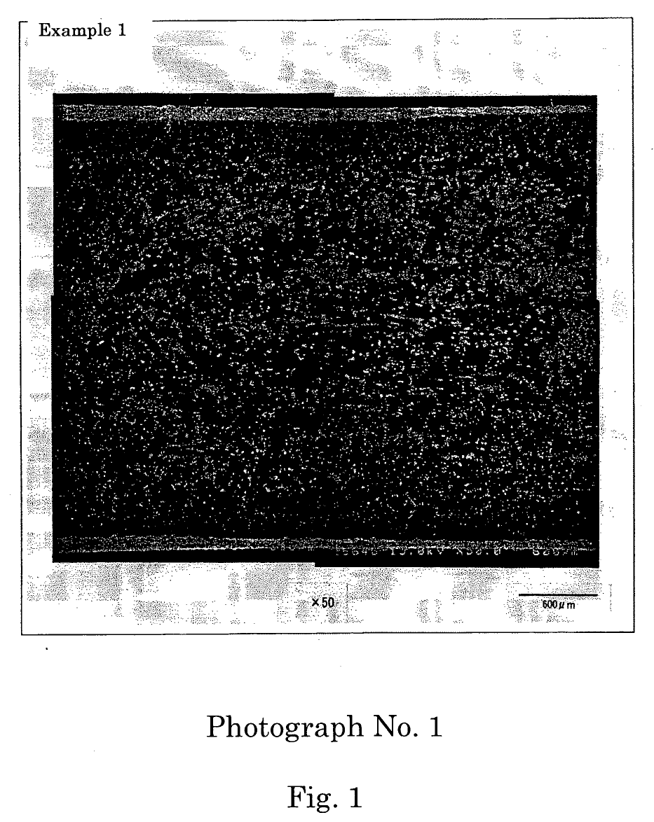

A formed article was obtained using pellets obtained in the same manner as that used in Comparative Example 1 except that the spread of a glass roving at its entrance into the crosshead die was increased to about 1.3 times by increasing the tension of the glass roving to be inserted. An intrinsic viscosity [η] of the polypropylene resin in the formed article, a degree of dispersion of the fibers in the formed article, and a fatigue characteristic of the formed article were determined in the same manners as those used in Comparative Example 1 and the results are shown in Table 1. Photograph 1 used in the measurement of the degree of dispersion of the fibers is shown in FIG. 1.

### Comparative Example 2

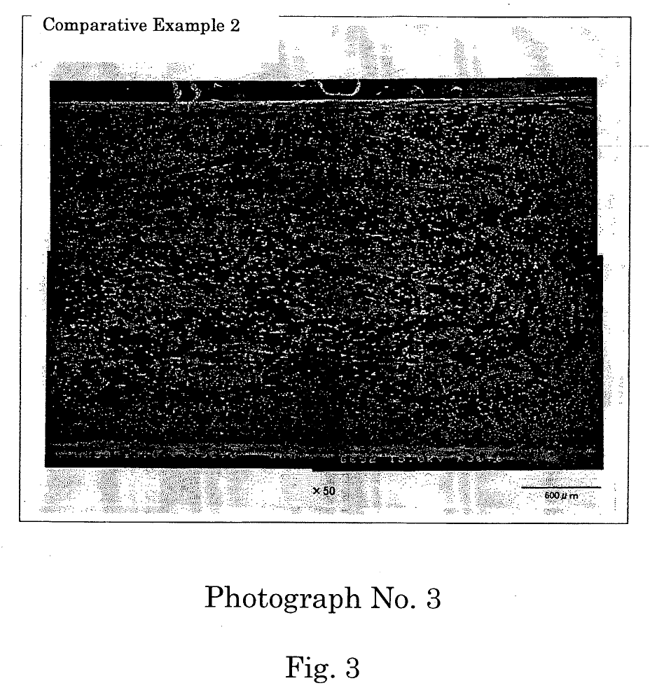

A formed article was obtained in the same manner as that used in Comparative Example 1 except that the propylene homopolymer (available as Sumitomo Noblene Z101A) was changed to a propylene resin (available as Sumitomo Noblene U501E-1) and the temperature of the crosshead was changed to 300° C. An intrinsic viscosity [η] of the polypropylene resin in the formed article, a degree of dispersion of the fibers in the formed article, and a fatigue characteristic of the formed article were determined in the same manners as those used in Comparative Example 1 and the results are shown in Table 1. Photograph No. 3 used in the measurement of the degree of dispersion of the fibers is shown in FIG. 3.

TABLE 1

| | Example | Comparative | Comparative |
|---|---|---|---|
| | 1 | Example 1 | Example 2 |
| Intrinsic viscosity [η] of | 1.21 | 1.10 | 1.01 |
| polypropylene resin in formed | | | |
| article (g/10 min) | | | |
| Weight average fiber length | 4.2 | 4.0 | 4.0 |
| (mm) | | | |
| Measurement of degree of | | | |
| dispersion | | | |
| Number of dispersed objects | 2452 | 1645 | 1727 |
| Average area (each dispersed | 1843 | 2420 | 2408 |
| object after expansion) μm² | | | |
| Standard deviation of area | 1945 | 3717 | 3207 |
| μm² | | | |
| Degree of dispersion | 1.1 | 1.5 | 1.3 |
| (expansion method) | | | |
| Result of Evaluation of | | | |
| Fatigue Characteristic | | | |
| Fatigue Strength (number of | 72973 | 49278 | 7080 |
| reciprocative vibrations) | | | |
| [at applied load of 50 MPa] | | | |
| Fatigue Strength (number of | 605577 | 188233 | 32312 |
| reciprocative vibrations) | | | |
| [at applied load of 45 MPa] | | | |
| Fatigue Strength (number of | 6065615 | 1175858 | 64454 |
| reciprocative vibrations) | | | |
| [at applied load of 40 MPa] | | | |

As described above, the present invention can afford a formed article made of a fiber-reinforced polypropylene resin having a superior mechanical strength and a superior fatigue characteristic.

What is claimed is:

1. A formed article made of a fiber-reinforced polypropylene resin comprising from 20 to 95% by weight of a polypropylene resin and from 5 to 80% by weight of fibers, wherein in the formed article the polypropylene has an intrinsic viscosity [η] of from 1.05 dl/g to 2.00 dl/g, the fibers have a weight average fiber length of from 1 mm to 10 mm, and a degree of dispersion of the fibers is from 0 to 1.2.

2. The formed article according to claim 1, wherein in the formed article the degree of dispersion of the fibers is from 0 to 1.1.

3. The formed article according to claim 1, wherein in the formed article the polypropylene resin has an intrinsic viscosity [η] of from 1.15 dl/g to 2.00 dl/g.

4. The formed article according to claim 1, wherein in the formed article the fibers have a weight average fiber length of from 1.5 mm to 10 mm.
